(19) United States
(12) Patent Application Publication
(10) Pub. No.: US 2002/0027775 A1
(43) Pub. Date: Mar. 7, 2002

(54) Decorative bubble light

(76) Inventor: James W. Gibboney JR., Conyers, GA (US)

Correspondence Address: MICHAEL A. MANN, NEXSEN PRUET JACOBS & POLLARD LLC, PO DRWR 2426, COLUMBIA, SC, 29202-2426, US

(21) Appl. No.: 09/810,729

(22) Filed: Mar. 15, 2001

Related U.S. Application Data
(60) Provisional application No. 60/189,708, filed on Mar. 15, 2000.

(51) Int. Cl. F21V 29/00; F21V 21/30

(52) U.S. Cl. 362/35; 362/294

(57) ABSTRACT

An improved bubbler light having a bubbler including an envelop with a fluid contained therein, a wire frame clipped to the envelope's base, a lamp extending into the wire frame and abase having a bottom with a hole in it, a hollow main body, and a top with a hole in it. The bubbler extends through the hole in the top of the base and the lamp extends through the hole in the bottom of the base. The wire frame helps to conduct heat from the lamp to the base of the bubbler so that it begins to bubble more quickly. The three-part base, allows the lamp to be changed if it burns out or if a different color of lamp is desired. The base can also be replaced with one of a different design.

### PRIORITY CLAIM

The applicant claims the benefit of the filing date of provisional application 60/189,708 filed Feb. 15, 2000.

### FIELD OF THE INVENTION

The present invention relates generally to decorative lighting and strings of lights. In particular, the present invention relates to the type of decorative lighting known as a bubble light.

### BACKGROUND OF THE INVENTION

A bubble light includes an illuminated, liquid-filled transparent envelop attached to a base. After the light has been turned on, the heat from the lamp in its base causes a series of bubbles to pass upwardly through the envelop. Bubble lights are found in strings of lights used for decorating Christmas trees. The wires connect into the base of the bubble light rather than in to a socket into which the bubble light was inserted.

Prior art bubble lights would begin to bubble within about 10-20 minutes because of the length of time it took them to heat the liquid in the envelop. When the lamp burned out, it could not be replaced. Prior art bubble lights had limited flexibility in other ways as well. The bubble light was one unit where the base had a color and shape and the light had a color and a brightness. These parameters were fixed.

There remains a need for improvements in the prior art bubble light.

### SUMMARY OF THE INVENTION

According to its major aspects and briefly recited, the present invention is a bubble light having five main components: a bottom, a lamp, a main body, a bubbler that includes a wire frame locked onto it, and a top. The main body, bottom and top may be replaced with components of a different color or shape. If the shape of the replacement body is different, the top and the bottom of it may also be shaped to correspond. The lamp may be incandescent, solid state or fluorescent and any wattage up to about 15 watts and in any color. Finally, the present bubble light is made to be inserted into a socket so the entire bubble light can be replaced merely by unscrewing the lamp. Thus, the present bubble light has considerably more flexibility than the prior art bubble light.

An important feature of the present invention is that the lamp of the present bubble light may be removed and replaced, thus allowing the user to maintain a full set of lights on a light string.

Another important feature of the present invention is the interchangeability of the main body, top and bottom of the bubble light with alternative main bodies, tops and bottoms. The advantage of this feature is that the remaining portions of the bubble light can be used with many different bases, for example, to celebrate different holidays of the year by using different base shapes.

Another important feature of the present invention is the use of a wire frame, preferably of metal, to help hold the lamp in position near the base of the envelope of the bubbler and to help conduct heat to the base of the envelop. The wire frame thus serves two functions.

Other features and their advantages will be apparent to those skilled in the art of decorative lighting from a careful reading of the Detailed Description of Preferred Embodiments, accompanied by the drawings.

### BRIEF DESCRIPTION OF THE DRAWINGS

In the drawings:

FIG. 1 is a side view of a bubble light, according to a preferred embodiment of the present invention;

FIG. 2 is an exploded, perspective view of the bubble light of FIG. 1;

FIG. 3 is a side view of the bubbler, according to a preferred embodiment of the present invention;

FIG. 4 is a side view of the bubble light of FIG. 1 without the bottom, main body and top, according to a preferred embodiment of the present invention;

FIG. 5 is a detailed view of the bubbler wire frame, according to a preferred embodiment of the present invention; and

FIGS. 6-9 are alternative embodiments of bubble lights, according to a preferred embodiments of the present invention.

### DETAILED DESCRIPTION OF PREFERRED EMBODIMENTS

The present invention is an improved bubble light made to be used singly or in a series with other bubble lights. When used in a series, the bubble lights may be connected electrically in series or in parallel.

The present bubble light, generally indicated by the reference number 10, comprises a bubbler 12, a lamp 14 and a base 16. Bubbler 12 is generally oriented with its major dimension vertical and has a generally cylindrical cross section, preferably with flutes 18 formed along its length. Its major dimension is preferably much longer than its minor dimension so that bubbles formed in its base 20 travel along this vertical dimension and collapse at the top 22 of bubbler.

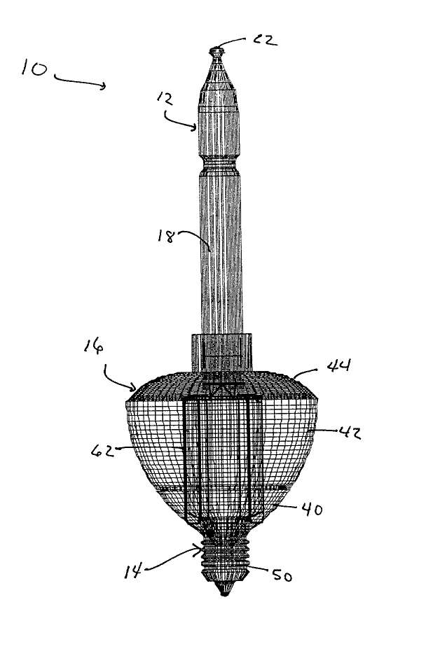

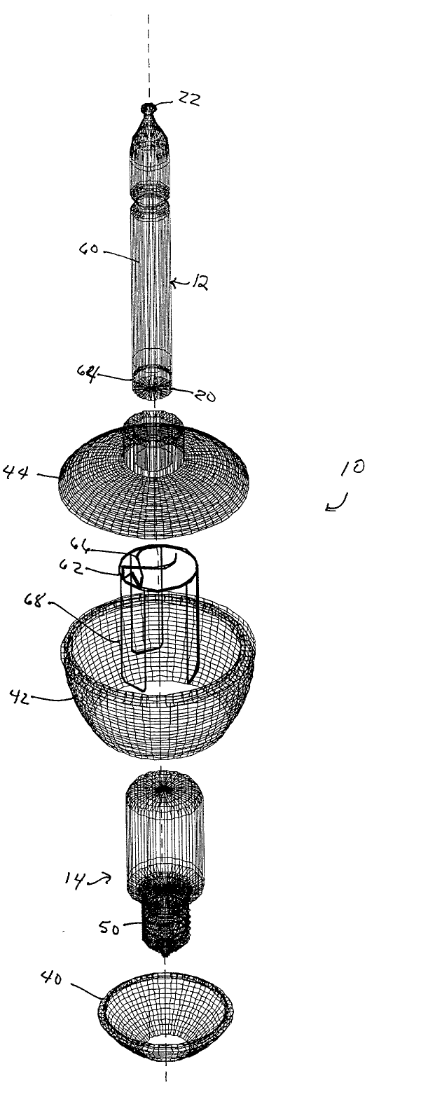

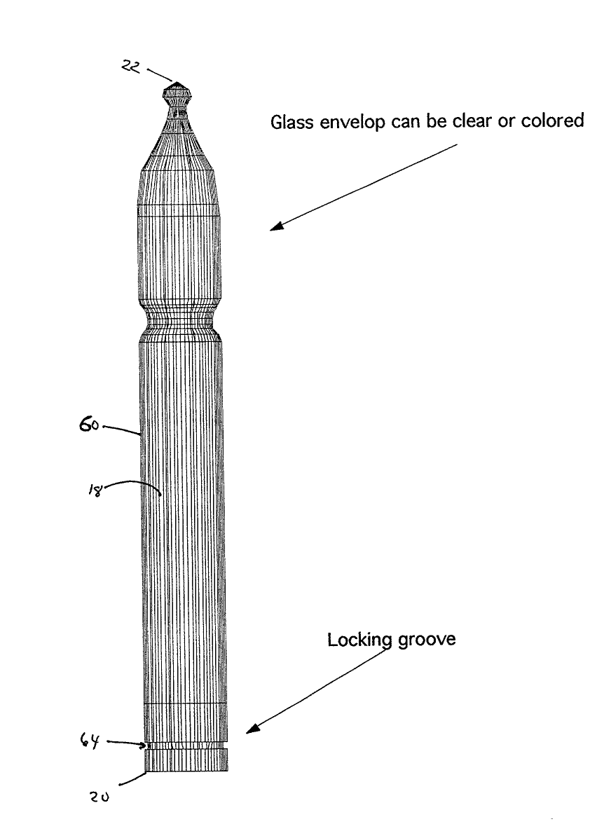

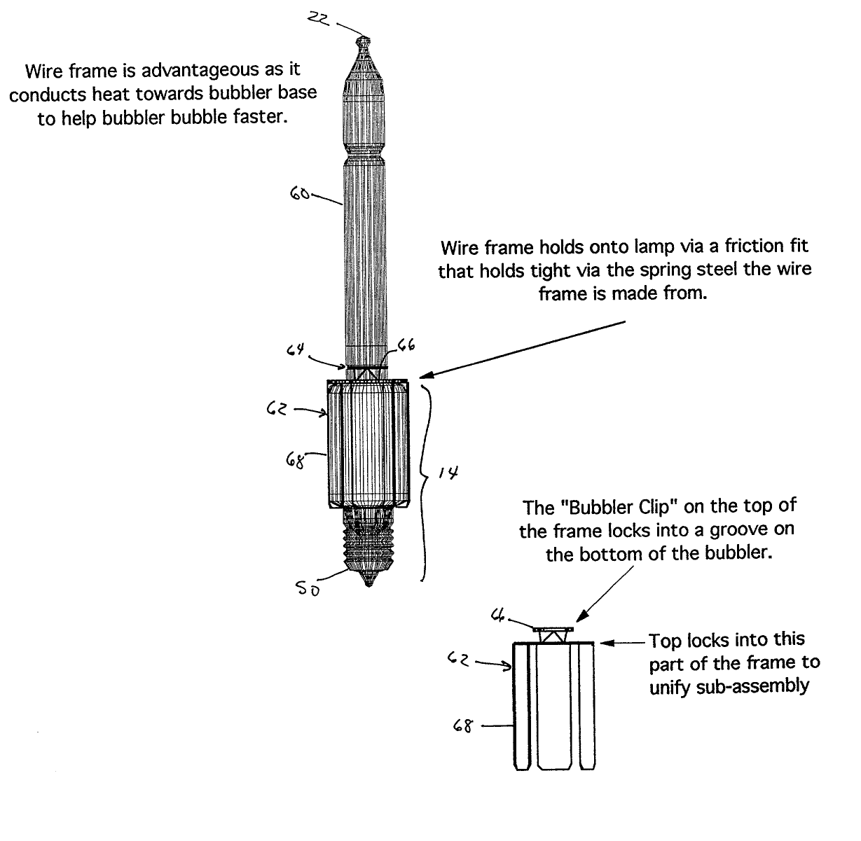

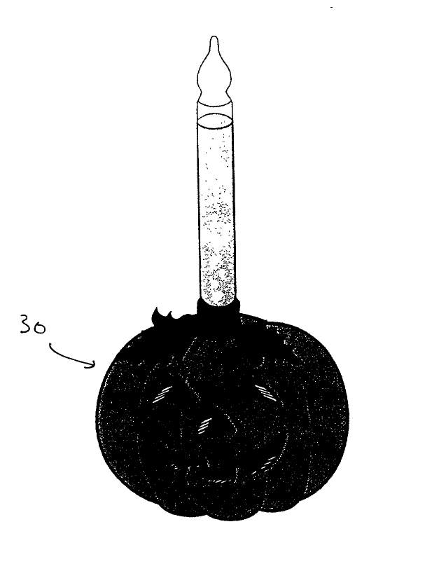

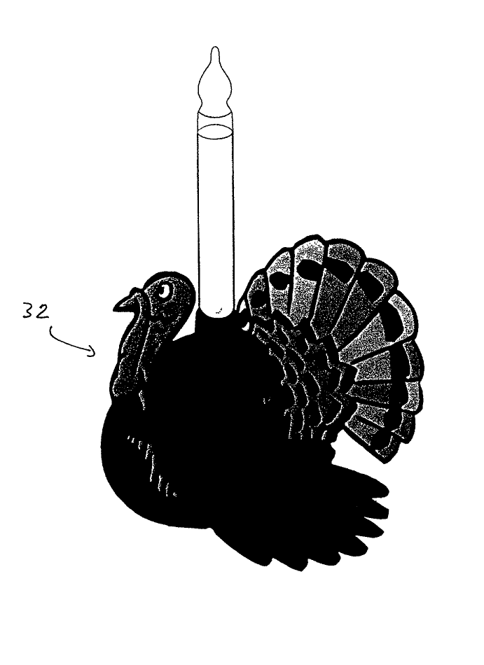

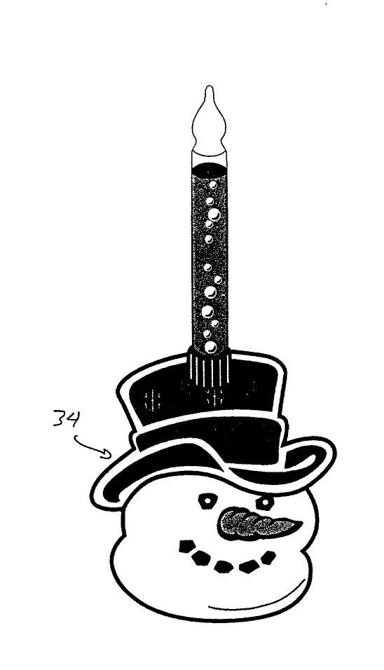

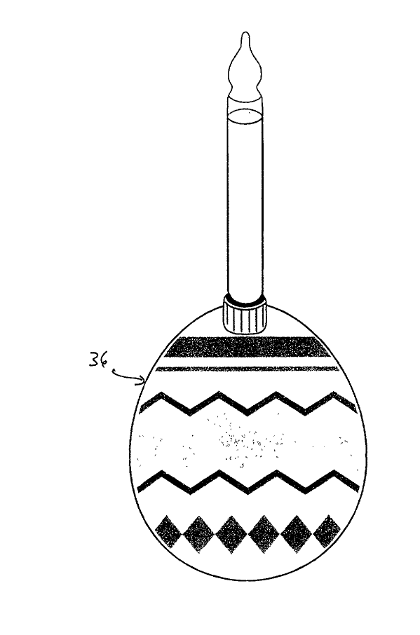

Base 16 is hollow and may have any shape as long as it is large enough to accommodate lamp 14 inside. Preferably, it has a generic shape, as illustrated in FIGS. 1-5, and other more specific shapes evocative of various holidays, as illustrated in FIGS. 6-9, which show bases in the shapes of a jack-o'lantern 30, a turkey 32, a snowman 34, and an Easter egg 36, respectively.

Importantly, base 16 is composed of three sections: a bottom 40, and main body 42, and top 44 that are form fitted together so that bottom 40 snaps into main body 42 in order to create the appearance of a whole. A hole 46 in bottom 40 accommodates a base 50 of lamp 14, preferably threaded to be received in a socket (not shown). Top 44 also has a hole 48 through which bubbler 12 may pass, extending upwardly from base 16. This arrangement allows the body of the bubbler 12 to be rotated under slight force when lamp 14 bottoms out in the socket (not shown) into which it is screwed so that the front of the base 16 can be aligned if base 16 has a preferred orientation, such as those in FIGS. 6-8. Preferably, bottom 40 or main body 42 would have a small slot formed near its edge for a screw driver or other tool to be inserted to separate bottom 40 from main body 42 when desired.

Bubbler 12 includes an envelop 60 and a wire frame 62. To connect envelop 60 to metal or plastic wire frame 62, a groove 64 is formed in envelop and spring clip 66 is formed from the ends of wire frame 62 that is just smaller than the dimensions of groove 64 so that clip, when fitted into groove 64, will hold wire frame 62 to envelop 60 and orient it about the base 20 of bubbler 12.

Wire frame 62 surrounds lamp 14 and fits close to it so that the heat from lamp 14 warms the base 20 of bubbler 12 directly and through wire frame 62 to cause bubbles to be formed in the fluid enveloped by envelop 60. Preferably wireframe 62 comprises a series of loops 68 surrounding the sides of lamp 14 and frictionally fitted to it so that lamp 14 can be slid into wire frame 62 and held in position by wire frame 62.

Lamp 14 may be any small lamp but is preferably one drawing 15 or fewer watts DC, AC at low or high voltage. Lamp 14 is preferably a standard size of small lamp such as a C7 typical of night light lamps or T7 as illustrated in the figures, or S6, all of which are standard sizes, readily available from a number of manufacturers.

In addition to the embodiments presented, another embodiment of the present invention includes within base 10 a dome rotatably fastened to a wire frame and formed with louvers to allow the thermal from lamp 14 to rotate it. Base 10 would be made of a transparent or translucent material and the dome may be colored so that base 10 from the exterior would appear to change color as the dome rotated within it. In still another embodiment of the present invention, base 10 is modified to receive and hold a scent-impregnated composite material, such as is sold by GLADE SCENT CARTRIDGE for use with other types of lamps, and which would give off scents associated with the holidays, such as pine. In yet a third embodiment of the present invention, base 10 is opaque except for a “window” of transparent or white translucent plastic towards the front of base 10 into which can be inserted a 35 mm slide for display.

It will be apparent to those skilled in the art of decorative lighting that many changes and substitutions can be made to the foregoing preferred embodiments without departing from the spirit and scope of the present invention, defined by the appended claims.

What is claimed is:

1. A bubbler light, comprising:
a bubbler with a wire frame attached to its base;
a base having a bottom with a hole, a hollow main body, and a top with a hole; and
a lamp dimensioned to be received within said main body and extend through said hole in said bottom and into said wire frame, said bubbler extending through said hole in said top.
